(19) United States
(12) Patent Application Publication
(10) Pub. No.: US 2008/0181715 A1
(43) Pub. Date: Jul. 31, 2008

(54) FOUNTAIN PEN FOR TRADITIONALLY WRITING JEWISH SCRIPTURE

(76) Inventor: Elazar Cohen, Nitsan (IL)

Correspondence Address: Elazar Cohen, 2 Ha'arava St, Nitsan, 79287, omitted

(21) Appl. No.: 12/023,052

(22) Filed: Jan. 31, 2008

(30) Foreign Application Priority Data
Jan. 31, 2007 (IL) 181089

(51) Int. Cl. B43K 5/00

(52) U.S. Cl. 401/232

(57) ABSTRACT

A fountain pen for traditionally writing Jewish scriptures on parchment and prolonging the time between refilling of a calamus tip is provided. The fountain pen includes a configured calamus tip. An ink loader feeds ink to the calamus tip. A reservoir stores the ink and a piston creates a customable pressure inside said reservoir. An ink collector accepts ink from the reservoir. An ink flow attenuator attenuates the ink flow that flows through the ink loader, and a hollow barrel having an open front and rear ends for housing the piston, ink loader, calamus and reservoir.

### FIELD OF THE INVENTION

The present invention is in the field of writing scripture on parchment. More specifically the invention pertains to a fountain pen for traditionally writing Jewish scripture on parchment.

### BACKGROUND OF THE INVENTION

A Sofer STAM is a Jewish scribe who can write traditional Jewish scripture. STAM is an acronym for three of the sacred Jewish scribal items: Sifrei Torah (scrolls containing the first five books of the Bible), Tefillin (also termed phylacteries; these are either of two boxes containing Biblical verses and black leather straps attached to them which are used in Jewish prayer), and mezuza, a parchment on which portions of the “Shema Israel” prayer are written, and which Jews are commanded to place on their doorposts. STAM must be written on parchment in black ink by a Torah-observant man. Very high demands are made of the ink. It must be coal black, without even a slightest tint, and durable and resilient in the face of centuries of existence. The ink is usually made of: coal, gals (small epiphyllous balls on the oak leafs), wood rosin, and blue vitriol. This mixture makes the ink ineffaceable. To apply the ink to the parchment it is customary to use a bird's feather, in most cases a turkey's feather. A feather pen is also known as a quill, or as a calamus, and hereinafter is referred to as calamus. The bottom part or the tip of the calamus is traditionally used for writing scripture on parchment. The tip of the calamus is specially prepared using a knife or other sharp edged instrument, by cutting and configuring the calamus tip to be suitable for traditional writing of Jewish scripture on parchment. A cylindrical hollow body made of plastic metal or other suitable material the bottom part of which is configured to suit traditional writing Jewish scripture on parchment is also referred to hereinafter as calamus.

In IL patent 131687 the contents of which are incorporated herewith by reference, a pen tip is disclosed featuring a specially configured and dimensioned pen tip edge, for traditionally writing Jewish scripture on parchment, and corresponding method and system of traditionally writing Jewish scripture on parchment.

### BRIEF DESCRIPTION OF THE DRAWINGS

FIG. 1A is an external schematic view of a fountain pen in accordance with a preferred embodiment of the present invention;

FIG. 1B is an external schematic view of a section of a fountain pen in accordance with a preferred embodiment of the present invention;

FIG. 2 is an exploded schematic view of a fountain pen in accordance with a preferred embodiment of the present invention;

FIG. 3 is an axial sectional view of a fountain pen in accordance with a preferred embodiment of the present invention;

FIG. 4 is an exploded schematic view of a fountain pen in accordance with another embodiment of the present invention;

FIG. 5 is an external schematic view of a lower section of a fountain pen in accordance with a preferred embodiment of the present invention placed in a bottle partly filled with water.

### DETAILED DESCRIPTION OF THE PRESENT INVENTION

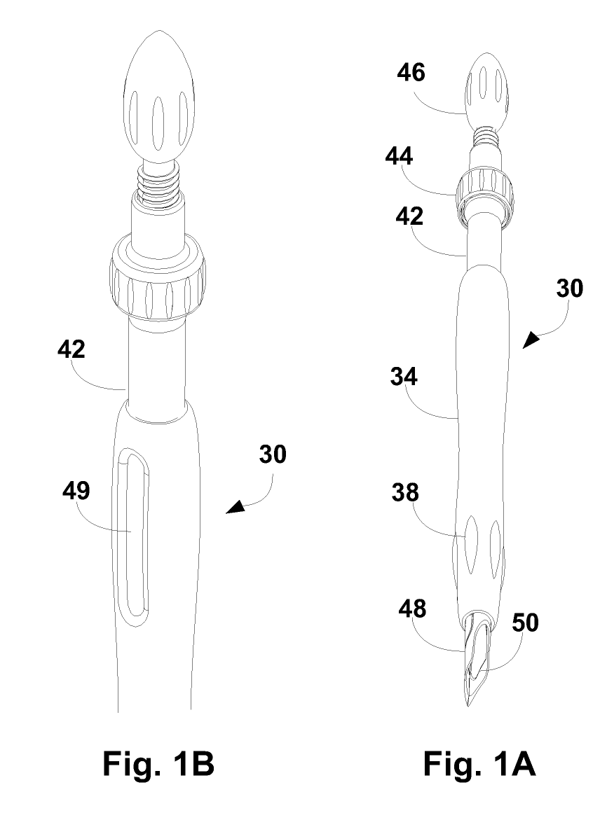

In accordance with the present invention a fountain pen for traditionally writing Jewish scripture on parchment and prolonging the time between refilling of a calamus tip is provided. An external view of an exemplary fountain pen in accordance with a preferred embodiment of the present invention is shown in FIG. 1A to which reference is now made. Fountain pen 30 includes hollow barrel 34 with two open ends and further includes gripping region 38. The hollow barrel houses cylinder 42, referred to hereinafter as ink reservoir. Connected to ink reservoir 42 is hollow connector member 44, on top of which gripping knob 46 is connected. Calamus tip 48 and ink loader 50 are connected to the lower opening of barrel 34. Referring to FIG. 1B, the amount of ink left in ink reservoir 42 can be viewed through transparent window 49 which is constructed from transparent glass or other suitable material.

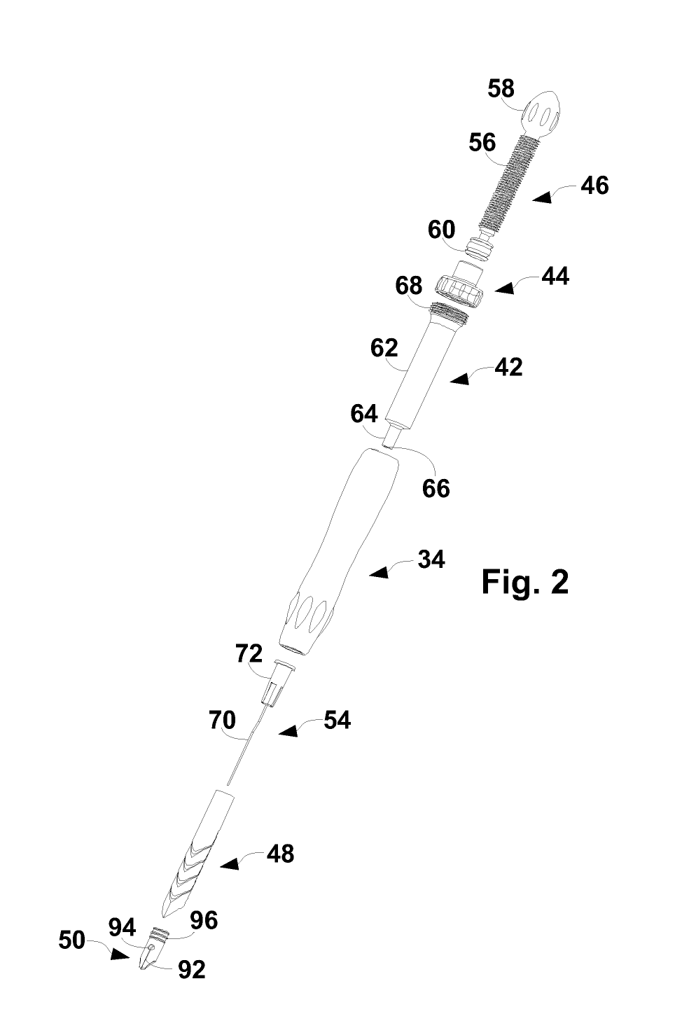

An exploded view of the fountain pen in accordance with a preferred embodiment of the present invention is described in FIG. 2 to which reference is now made. The fountain pen consists of piston 46, ink reservoir 42, connector member 44, hollow barrel 34, structured needle 54, calamus 48 and ink loader 50. The piston consists of rod 56 typically threaded, gripping knob 58 and plunger 60. Attached to the upper end of threaded rod 56, gripping knob 58 is used for threading the rod to the inner thread of the connector member. Plunger 60 is connected to the lower end of rod 56. The plunger can be made of rubber, or any other suitable material. Reservoir 42 is contained within cylindrical hollow tube 62 which tapers in one end forming funnel 64. The tube is made of plastic or glass or any other suitable material. Ink can be either discharged or sucked in through the outlet at the lower end of funnel 66. The other end of the reservoir is threaded 68 on the outside in order to be connected with one end of the connector member 44. Structured needle 54 has a hollow bore referred to hereinafter as channel 70 that runs longitudinally through the structured needle. The needle is attached to the bottom reservoir body via needle holder 72. Ink loader 50, which is used also as a secondary reservoir, is a tube made of plastic, metal or other suitable material. The lower end of the tube is closed and typically asymmetrically tapered towards the extreme end, such that the side opposite the calamus is slanted. On the other side through groove 92 and hole 94 are formed; hole 94 is formed in the upper end of the groove. At least one annular ring 96 is formed around the ink loader's upper end for attaching it to the inside of calamus 48.

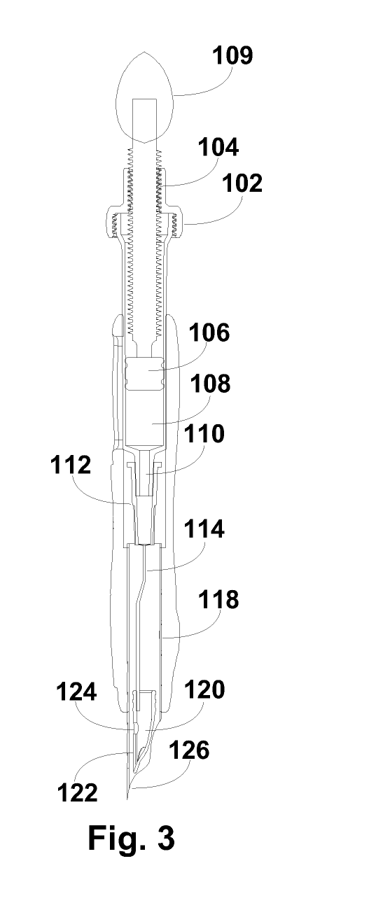

An axial sectional view of an exemplary fountain pen assembly in accordance with a preferred embodiment of the present invention is described in FIG. 3 to which reference is now made. Connector member 102 and piston 104 can be removed from reservoir 108. Filling of the reservoir and control of the ink flow direction and amount is carried out by the piston. The piston can be pushed and pulled along inside reservoir 108 by hand-winding piston gripping knob 109. When piston 104 is pushed down inside the reservoir, the ink in reservoir 108 is pressured downwards into needle holder 112 and guided through structured needle 114. When the piston is pulled up along inside the reservoir a certain amount of ink stored in the ink loader is pulled up through the structured needle back to the reservoir. The structured needle is mounted inside calamus 118 and is formed such that the needle tip leans against the internal side of ink loader 120 in the centreline axial of the ink loader through groove 122 and pierce 124. The lower end of the ink loader is closed and typically asymmetrically tapered towards the extreme end, such that the side opposite the calamus is slanted. Some of the liquid ink in the ink loader flows out from the ink loader through pierce 124 and is guided through the ink loader groove towards the tip of calamus 126 which is especially configured for traditionally writing Jewish scripture on parchment.

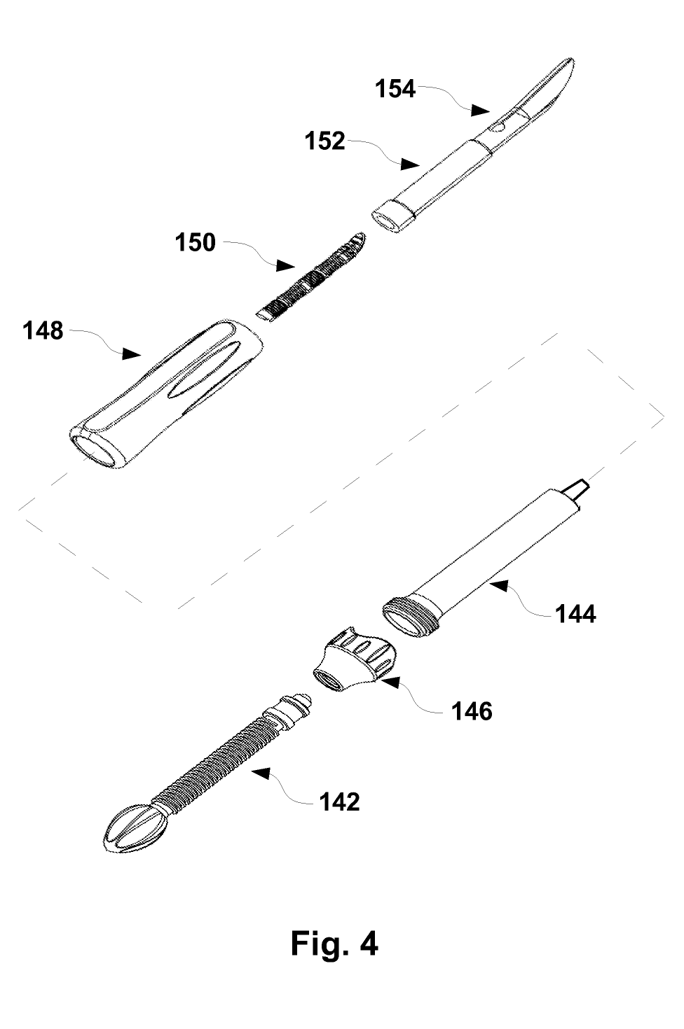

An exploded schematic view of a fountain pen in accordance with another embodiment of the present invention is described in FIG. 4 to which reference is now made. The fountain pen of the invention consists of piston 142, ink reservoir 144, connector member 146, hollow barrel 148, ink flow attenuator 150, ink collector 152, ink loader 154 and calamus, not shown. Ink flow attenuator 150 is installed within ink loader 154. The ink that is discharged through the outlet at the lower end of ink reservoir 144 is collected by ink collector 152 which has at its lower end a hole through which the collected ink flows into ink loader 154. Ink flow attenuator 150 attenuates the ink that flows through ink loader 154. The calamus covers ink loader 154 and ink collector 152. The calamus is gripped by hollow barrel 148 which has a holder means at its lower end, not shown, for gripping the calamus.

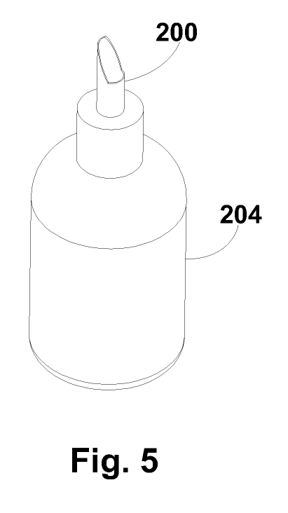

In time, the tip of the calamus, made of feather, in contact with the ink, softens, swells and expands. Consequently, these changes in the tip ordinarily cause changes in size and form of the Jewish scripture and therefore, a decrease of overall writing efficiency and quality. In one aspect of the present invention, explained with reference FIG. 5, while the fountain pen is not in use, the lower section of fountain pen 200 in accordance with the preferred embodiment of the present invention is placed in bottle 204 partly filled with water. The water in the bottle raises the humidity in the cavity of the bottle in order to preserve the calamus tip from the aforementioned changes. Furthermore referring once more to FIG. 3 the moisture keeps the ink in the tip of structured needle 114 in liquid state during the period of time that the fountain pen is not in use thus preventing blockage in the needle.

### Benefits of the Present Invention

To date, stationery used by the majority of STAM scribes uses for traditionally writing a Jewish scripture on parchment is a calamus feather pen typically made from a feather of a turkey. The process of writing with such a pen is as follows: the scribe immerses the calamus tip in an inkwell after which he can write a few letters. Using a fountain pen provided by the invention enables the scribe to write more words without dipping the pen, promoting thus speed of writing and a more steady style. An additional benefit is the reduction in the risk that ink drops stain the parchment, by using the piston to control the amount of ink on the calamus tip.

1. A fountain pen for traditionally writing Jewish scriptures on parchment comprising:
a configured calamus tip for a traditionally writing Jewish scripture on parchment;
an ink loader for feeding ink to said calamus tip;
a reservoir for storing said ink;
a piston for creating a customable pressure inside said reservoir and,
a hollow barrel having an open front and rear ends for housing said piston, ink loader, calamus and reservoir.

2. A fountain pen for traditionally writing Jewish scriptures on parchment as in claim 1, wherein a needle is connected to the outlet of said reservoir, guiding the ink from said reservoir to said ink loader.

3. A fountain pen for traditionally writing Jewish scriptures on parchment as in claim 1, wherein said fountain pen further comprises a means for gripping.

4. A fountain pen for traditionally writing Jewish scriptures on parchment as claimed in claim 1, wherein said hollow barrel further comprises a transparent window.

5. A fountain pen for traditionally writing Jewish scriptures on parchment as claimed in claim 1, wherein said piston rod is threaded.

6. A container means for a pen as in claim 1, wherein the lower section of said pen is mounted in a closed compartment thereof, for keeping said pen humid to avoid drying of said section.

7. A fountain pen for traditionally writing Jewish scriptures on parchment as in claim 1, wherein said fountain pen further comprising:
an ink collector for collecting ink from said reservoir;
an ink flow attenuator for attenuating the ink flow that flows through said ink loader;

8. A fountain pen for traditionally writing a Jewish scripture on parchment as in claim 1, wherein said calamus is passed through said ink loader.

9. A method for feeding ink to a calamus tip used for continuous writing of a traditional Jewish scripture on parchment, said method comprising:
filling a reservoir by controlling the ink flow direction;
controlling the flow of ink between said reservoir and an ink loader using a structured needle, and
guiding the ink from the ink loader to said calamus tip.

10. A method for preserving ink in liquid state at the lower section of fountain pen used for a traditionally writing a Jewish scripture on parchment, wherein said method comprises mounting said lower section of said fountain pen in a humid compartment within a container.
